(19) United States
(12) Patent Application Publication
(10) Pub. No.: US 2026/0113829 A1
(43) Pub. Date: Apr. 23, 2026

(54) ELECTROSTATIC DISCHARGE MECHANISM FOR A CARD PERSONALIZATION SYSTEM

(71) Applicant: Entrust Corporation, Shakopee, MN (US)

(72) Inventors: Ryan BOUDREAU, Shakopee, MN (US); Rob SELLS, Shakopee, MN (US)

(21) Appl. No.: 19/359,169

(22) Filed: Oct. 15, 2025

Related U.S. Application Data
(60) Provisional application No. 63/708,454, filed on Oct. 17, 2024.

(51) Int. Cl. H05F 1/00

(52) U.S. Cl. CPC H05F 1/00

(57) ABSTRACT

An electrostatic discharge mechanism for use in a card personalization system. The electrostatic discharge mechanism is positioned and configured to contact an integrated circuit chip on a card prior to the card being input into an integrated circuit chip programming mechanism of an integrated circuit chip programming station. The electrostatic discharge mechanism discharges electrostatic energy that accumulates in the card, for example in an embedded antenna that is electrically connected to the integrated circuit chip, prior to operations on the card by the integrated circuit chip programming mechanism. The electrostatic discharge mechanism can be a static dissipative material, for example a static dissipative polymeric material.

### PRIORITY

This application claims the benefit of U.S. Provisional Application Ser. No. 63/708454 filed on Oct. 17, 2024, the entire contents of which are incorporated herein by reference.

### FIELD

The technology described herein relates to card personalization systems that use an integrated circuit chip programming station to program an integrated circuit chip on a card.

### BACKGROUND

Card personalization systems that include an integrated circuit chip programming station are known. The integrated circuit chip programming station may be configured to test operability of a programmable integrated circuit chip on a card, read data from the integrated circuit chip, and/or program data onto the integrated circuit chip. The integrated circuit chip may be a contactless chip that is electrically connected to an antenna that is embedded in the card, and where programming of data to or reading data from the integrated circuit chip occurs without direct contact with the integrated circuit chip. The integrated circuit chip programming station may be configured to program an integrated circuit chip on a single card at any one time, or configured to simultaneously program integrated circuit chips on multiple cards.

### SUMMARY

An electrostatic discharge mechanism for use in a card personalization system is described. The electrostatic discharge mechanism is positioned and configured to contact an integrated circuit chip on a card prior to the card being input into an integrated circuit chip programming mechanism of an integrated circuit chip programming station. The electrostatic discharge mechanism discharges electrostatic energy that accumulates in or on a portion of the card, for example in an embedded antenna that is electrically connected to the integrated circuit chip, prior to operations on the card by the integrated circuit chip programming mechanism.

In an embodiment, the electrostatic discharge mechanism can be formed from static dissipative material. The static dissipative material may be a static dissipative polymeric material. The static dissipative polymeric material can be any polymer material that is suitable for contacting the integrated circuit chip to discharge electrostatic energy. An example of a suitable static dissipative polymer includes, but is not limited to, a carbon impregnated nylon.

The electrostatic discharge mechanism can have any form or shape suitable for contacting the integrated circuit chip. In an embodiment, the electrostatic discharge mechanism may be in the form of a brush having a plurality of flexible polymer bristles, or in the form of a flexible block of polymer material.

The electrostatic discharge mechanism, whether in brush form or any other form, can have a width that is sufficient to contact enough of the width of the integrated circuit chip to discharge sufficient electrostatic energy. In an embodiment, the electrostatic discharge mechanism can have a width that is equal to or greater than the width of the integrated circuit chip. The width of the electrostatic discharge mechanism may also be equal to or less than the width of the card.

In an embodiment, the electrostatic discharge mechanism can have a width that is less than the width of the integrated circuit chip.

In an embodiment, when mounted in position, the electrostatic discharge mechanism is disposed at an acute angle to the card track defining the travel path of the card. In addition, the electrostatic discharge mechanism may also be pivotable relative to the card track along which the card travels.

In an embodiment, a card personalization system described herein may comprise a card input that is configured to input a card onto a card track, where the card has an integrated circuit chip and an antenna embedded in the card that is electrically connected to the integrated circuit chip. A card output is configured to output the card after being processed in the card personalization system. An integrated circuit chip programming station is located downstream from the card input along the card travel path, and the integrated circuit chip programming station includes an integrated circuit chip programming mechanism that is configured to program the integrated circuit chip on the card after the card is input into the integrated circuit chip programming station. An electrostatic discharge mechanism is positioned upstream of the integrated circuit chip programming mechanism, where the electrostatic discharge mechanism includes a static dissipative material and the electrostatic discharge mechanism is positioned and configured to contact the integrated circuit chip on the card prior to the card being input into the integrated circuit chip programming mechanism.

The card input may be configured to hold multiple cards and feed cards one-by-one onto the card track. Alternatively, the card input may be configured as a slot through which a single card is fed onto the card track.

The card output may be configured to hold multiple cards and receive processed cards one-by-one. Alternatively, the card output may be configured as a slot through which a processed card is output.

The electrostatic discharge mechanism may be part of the integrated circuit chip programming station, or separate from the integrated circuit chip programming station.

The electrostatic discharge mechanism may be associated with the integrated circuit chip programming station in any manner to discharge electrostatic energy prior to programming the integrated circuit chip in the integrated circuit chip programming mechanism. For example, the electrostatic discharge mechanism may be upstream of the integrated circuit chip programming mechanism, or downstream of the integrated circuit chip programming mechanism, or positioned above the integrated circuit chip programming mechanism, or positioned below the integrated circuit chip programming mechanism. The electrostatic discharge mechanism may be positioned anywhere that allows the electrostatic discharge mechanism to discharge electrostatic energy prior to programming the integrated circuit chip.

The integrated circuit chip programming station may include a single integrated circuit chip programming mechanism, or two or more integrated circuit chip programming mechanisms, for example 5 or more integrated circuit chip programming mechanisms, or 10 or more integrated circuit chip programming mechanisms, or 15 or more integrated circuit chip programming mechanisms, or 20 or more integrated circuit chip programming mechanisms.

The integrated circuit chip programming station may include at least one location where a card can pass through the station without programming of the integrated circuit chip thereof. The location(s) may be a pass-through slot that is devoid of an integrated circuit chip programming mechanism, or the location(s) may be an integrated circuit chip programming mechanism through which the card may pass without programming of the integrated circuit chip.

When multiple integrated circuit chip programming mechanisms are provided, the integrated circuit chip programming mechanisms may be arrayed in a barrel configuration, arrayed in a rack configuration, arrayed in a carousel configuration, or arrayed in any other configuration that can move relative to the card track and that can program cards as the array moves.

The electrostatic discharge mechanism may be disposed at an acute angle to the card track, or disposed at a right angle or perpendicular to the card track.

The electrostatic discharge mechanism may be pivotable relative to the card track, or the electrostatic discharge mechanism may non-pivotable and fixed in position relative to the card track.

In an embodiment, an integrated circuit chip programming station is described that is configured for use in a card personalization system and operable with a card which has an integrated circuit chip and an embedded antenna that is electrically connected to the integrated circuit chip. The integrated circuit chip programming station can include at least one integrated circuit chip programming mechanism, where the at least one integrated circuit chip programming mechanism is configured to program the integrated circuit chip on the card received thereby. A card track leads to the at least one integrated circuit chip programming mechanism, and an electrostatic discharge mechanism is positioned adjacent to the card track. The electrostatic discharge mechanism includes a static dissipative material and the electrostatic discharge mechanism is positioned and configured to contact the integrated circuit chip on the card prior to the card being input into the at least one integrated circuit chip programming mechanism.

In another embodiment, an integrated circuit chip programming station is described that is configured for use in a card personalization system and is operable with cards each of which has an integrated circuit chip and an embedded antenna that is electrically connected to the integrated circuit chip. The integrated circuit chip programming station can include a plurality of integrated circuit chip programming mechanisms, each one of the integrated circuit chip programming mechanisms is configured to program the integrated circuit chip on a respective one of the cards received thereby, whereby the integrated circuit chip programming mechanisms can simultaneously program the integrated circuit chips on a plurality of the cards. The station can also include a card track leading to the integrated circuit chip programming mechanisms, and the integrated circuit chip programming mechanisms are movable relative to the card track. An electrostatic discharge mechanism is located adjacent to the card track upstream of the integrated circuit chip programming mechanisms, and the electrostatic discharge mechanism includes a static dissipative material and the electrostatic discharge mechanism is positioned and configured to contact the integrated circuit chips on the cards prior to the cards being input into the respective integrated circuit chip programming mechanisms.

In another embodiment, an electrostatic discharge kit is described that is configured for installation in an integrated circuit chip programming station in a card personalization system. The integrated circuit chip programming station includes an integrated circuit chip programming mechanism that is configured to program an integrated circuit chip on a card after the card is input into the integrated circuit chip programming station. The electrostatic discharge kit can include an electrostatic discharge mechanism that is configured to be mounted at a location associated with the integrated circuit chip programming station, for example in the integrated circuit chip programming station upstream of the integrated circuit chip programming mechanism, where the electrostatic discharge mechanism includes a static dissipative material. When the electrostatic discharge mechanism is mounted in position, the electrostatic discharge mechanism is positioned and configured to contact the integrated circuit chip on the card prior to the card being input into the integrated circuit chip programming mechanism.

In another embodiment, a method of discharging electrostatic energy from a card with an integrated circuit chip and an antenna prior to feeding the card into integrated circuit chip programming mechanism is described. The method can include mounting an electrostatic discharge mechanism adjacent to a card track along which the card travels, for example upstream of the integrated circuit chip programming mechanism, where the electrostatic discharge mechanism includes a static dissipative material, then directing the card past the electrostatic discharge mechanism so that the electrostatic discharge mechanism contacts the integrated circuit chip, and thereafter feeding the card into the integrated circuit chip programming mechanism.

### DRAWINGS

FIG. 1 is a schematic depiction of an embodiment of a card personalization system that includes an integrated circuit chip programming station described herein.

FIG. 2 depicts an example of a card described herein with a contactless integrated circuit chip.

FIG. 3 is a schematic depiction of another embodiment of a card personalization system that includes the integrated circuit chip programming station described herein.

FIG. 4 is a schematic depiction of an embodiment of the integrated circuit chip programming station described herein.

FIG. 5 is a perspective view of an example of an electrostatic discharge mechanism described herein.

FIG. 6 is a top view of the electrostatic discharge mechanism of FIG. 5.

FIG. 7 is a schematic view of an embodiment of an integrated circuit chip programming station that includes a plurality of integrated circuit chip programming mechanisms.

FIG. 8 is a schematic view of another embodiment of an integrated circuit chip programming station that includes a plurality of integrated circuit chip programming mechanisms.

FIG. 9 is a schematic view of another embodiment of an integrated circuit chip programming station that includes a plurality of integrated circuit chip programming mechanisms.

### DETAILED DESCRIPTION

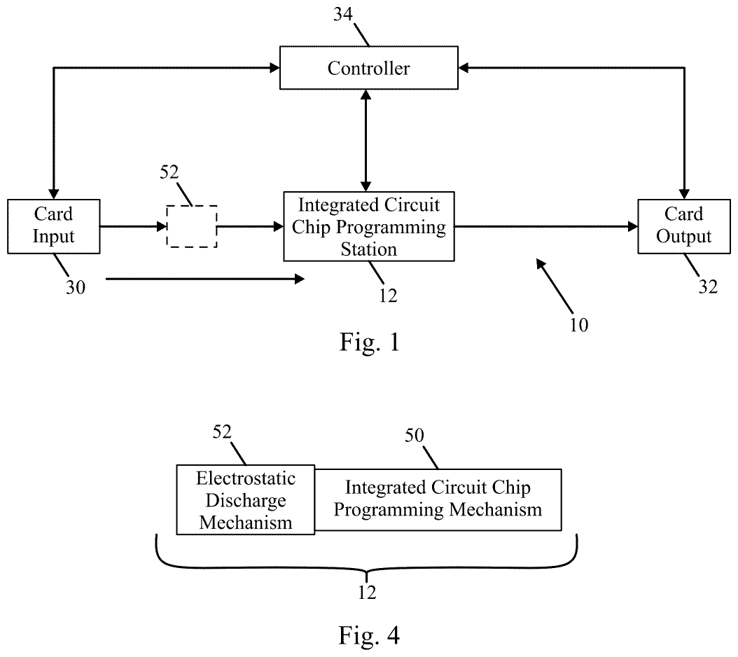

Referring to FIG. 1, an example of a card personalization system 10 is depicted that utilizes an integrated circuit chip programming station 12 described herein. The term “personalize” or “personalization” is often used in the card industry to refer to cards that undergo both personalization processing operations and non-personalization processing operations. The card personalization system 10 may also be referred to as a card processing system. Examples of operations that are performed on a card that results in personalizing the card include, but are not limited to, programming an integrated circuit chip on the card to include the card holder name, printing the card holder name on the card, programming the chip with an account number assigned to the card holder, printing the card holder account number on the card, and the like. Examples of operations that do not personalize the card include, but are not limited to, applying a laminate to the card, testing the chip on the card to determine if the chip is functioning properly, reading data from the chip, printing non-cardholder graphics on the card, and the like.

The card described herein can be any type of card that is issued to a card holder. Examples of cards include, but are not limited to, financial (e.g., credit, debit, or the like) cards, access cards, driver's licenses, national identification cards, business identification cards, and other cards. The card can be formed entirely of plastic, formed of a combination of plastic and non-plastic material, or formed mostly or completely of non-plastic materials such as metal. The card industry sometimes refers collectively to this type of card as a “plastic card” regardless of whether the card is formed entirely or partially of plastic materials or formed entirely of non-plastic materials. In one embodiment, the card can be sized to comply with ISO/IEC 7810 with dimensions of about 85.60 millimeters by about 53.98 millimeters (about 3⅜ in×about 2⅛ in) and rounded corners with a radius of about 2.88-3.48 mm (about ⅛ in).

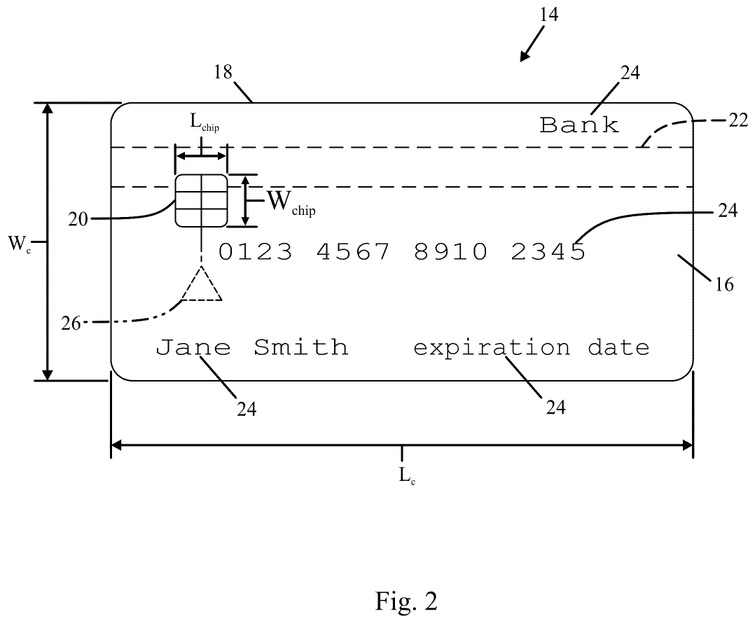

FIG. 2 illustrates an example of a card 14 with which the concepts described herein can be employed. In this example, the card 14 is shown to include a front surface 16, a rear or back surface (not shown) opposite the front surface 16, and a perimeter edge 18. The card 14 includes at least one integrated circuit chip 20, an optional magnetic strip 22 typically located on the back surface, and printed data 24 some of which may be personal data and some of which may be non-personal data. In this example, the chip 20 is configured for contactless programming in which case the card 14 further includes an antenna 26 embedded therein which is electrically connected to the chip 20. As used herein, the term “programming” of the chip 20 is intended to encompass actual programming of data onto the chip as well as testing the chip 20 to determine whether the chip 20 is functioning properly or not and reading data from the chip 20. In addition, the term “contactless” as used herein refers to interactions between the chip 20 and a programming head of an integrated circuit chip programming mechanism of the integrated circuit chip programming station 12 that occur without requiring direct physical contact with the chip 20. However, in an embodiment, there may be contact between the chip 20 and the programming head. The general construction and operation of integrated circuit chips, reading data therefrom and programming data thereon is known.

With continued reference to FIG. 2, the card 14 has a length L_{c} and a width W_{c}. The length L_{c} is typically greater than the width W_{c}, although in another embodiment they may be equal, or in another embodiment the width W_{c} may be greater than the length L_{c}. The chip 20 also has a length L_{chip} and a width W_{chip}. In the illustrated example, the length L_{chip} equals the width W_{chip}, although in another embodiment the length L_{chip} may be greater than the width W_{chip}, or in another embodiment the length L_{chip} may be less than the width W_{chip}.

Returning to FIG. 1, the system 10 may also include a card input 30, a card output 32, and a controller 34 that controls operation of the integrated circuit chip programming station 12, the card input 30, and the card output 32.

The card input 30 can be configured to hold a plurality of cards waiting to be personalized and that mechanically feeds the cards one by one into the system 10 using a suitable card feeder. In this configuration, the card input 30 is often termed a card input hopper. The construction and operation of card inputs and card input hoppers is well known in the art. The card input 30 can be configured with a multihopper configuration where the card input 30 is configured to simultaneously hold different card stock (for example, Visa® and Mastercard® branded card stock; driver's license card stock from different states; identification card stock having different security levels; etc.) waiting to be processed. Each type of card stock can be selectively input into the system 10 as selected by the controller 34 based on the type of card to be personalized. In another embodiment, the card input 30 can be configured as an input slot that permits cards to be fed, for example manually, one-by-one into the system 10.

The card output 32 can be configured to hold a plurality of cards after they have been personalized. In this configuration, the card output 32 is often termed a card output hopper. The construction and operation of card output hoppers is well known in the art. Like the card input 30, the card output 32 can also be configured with a multihopper configuration where the card output 32 is configured to simultaneously hold different card stock (for example, Visa® and Mastercard® branded card stock; driver's license card stock from different states; identification card stock having different security levels; etc.) after they have been personalized. Each type of card stock can be selectively output from the system 10 as selected by the controller 34 based on the type of card that has been personalized. In another embodiment, the card output 32 can be configured as an output slot from which the personalized cards are discharged one by one from the system 10.

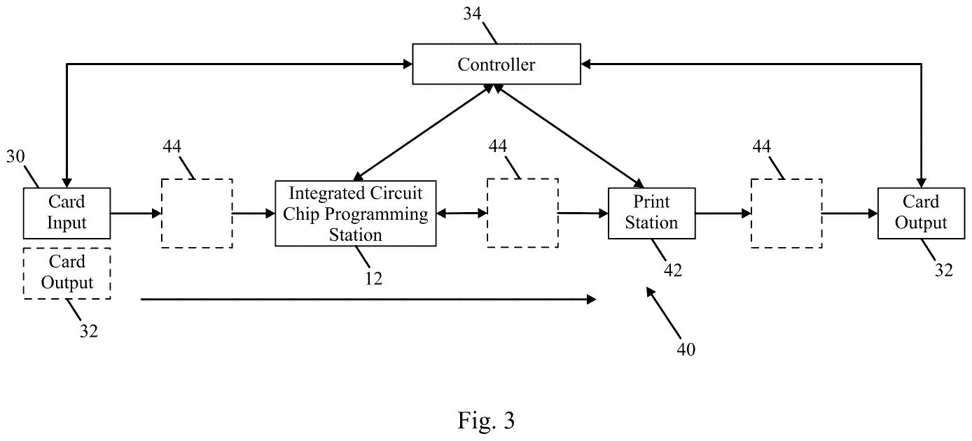

FIG. 1 depicts the integrated circuit chip programming station 12 located downstream from the card input 30 and between the card input 30 and the card output 32. A card that is input from the card input 30 travels along a card track defining a card travel path in the direction of the arrow from the card input 30, through the integrated circuit chip programming station 12, and to the card output 32. In another embodiment, the card output 32 may be located at the same end of the system 10 as the card input 30 whereby the integrated circuit chip programming station 12 is downstream from both the card input 30 and the card output 32. The card output 32 may be located elsewhere in the system 10 including at a top of the system 10 or at a bottom of the system 10. FIG. 1 also depicts the integrated circuit chip programming station 12 as being the only card personalization station in the system 10. However, the system 10 can include one or more additional card personalization systems as explained below with respect to FIG. 3.

Another possible embodiment of a card personalization system 40 is depicted in FIG. 3. In FIG. 3, elements that are the same as or similar to elements in FIG. 1 are referenced using the same reference numerals. The system 40 in FIG. 3 includes the integrated circuit chip programming station 12, the card input 30, the card output 32 and the controller 34. The system 40 in FIG. 3 may also include a print station 42 and one or more optional additional card personalization stations 44.

The print station 42 is downstream from the card input 30 and is controlled by the controller 34. The print station 42 is configured to perform printing on the cards. The print station 42 can be configured to perform any type of printing known in card personalization including, but not limited to, drop-on-demand printing, retransfer printing, and direct-to-card thermal transfer printing. The print station 42 is depicted as being downstream of the integrated circuit chip programming station 12. However, the print station 42 may be positioned at other locations in the system 40, including upstream of the integrated circuit chip programming station 12.

One or more of the optional additional card personalization stations 44 may be positioned between the card input 30 and the integrated circuit chip programming station 12, and/or one or more of the optional additional card personalization stations 44 may be positioned between the integrated circuit chip programming station 12 and the print station 42, and/or one or more of the optional additional card personalization stations 44 may be positioned between the print station 42 and the card output 32. The one or more additional card personalization stations 44 can be stations that are configured to perform any type of additional card personalization/processing controlled by the controller 34. Examples of the additional card personalization stations 44 include, but are not limited to, a magnetic strip encoder for encoding data on the magnetic strip of the card, an embossing station having an embosser configured to emboss characters on the cards, an indent station having an indenter configured to indent one or more characters on the cards, a laser marking station with a laser configured to perform laser marking on the cards, a lamination station with a laminator configured to apply one or more laminates to the cards, a topcoat station with a topcoat applicator configured to apply a topcoat to one or more of the surfaces of the cards, a security station with a security feature applicator configured to apply a security feature to one or more of the surfaces of the cards, and one or more card reorienting mechanisms/flippers configured to rotate or flip a card 180 degrees for processing on both sides of the cards.

In FIG. 3, a card that is input from the card input 30 travels along a card track defining a card travel path in the direction of the arrow from the card input 30, through the integrated circuit chip programming station 12, through the print station 42, optionally through any of the optional additional card personalization stations 44, and to the card output 32. In another embodiment, the card output 32 (depicted in broken lines) may be located at the same end of the system 10 as the card input 30 whereby the integrated circuit chip programming station 12 and the print station 12 are downstream from both the card input 30 and the card output 32. When the card output 32 (depicted in broken lines) is located at the same end of the system 10 as the card input 30, the cards initially travel in the direction of the arrow in FIG. 3, but the travel direction of the cards is reversible to permit the cards to be transported in a reverse direction into the card output 32 after processing is complete.

In the systems 10, 40 in FIGS. 1 and 3, the cards can be transported throughout the systems 10, 40 and moved along the card tracks by one or more suitable mechanical card transport mechanisms (not shown). Mechanical card transport mechanism(s) for transporting cards in card personalization equipment of the type described herein are well known in the art. Examples of mechanical card transport mechanisms that could be used are known in the art and include, but are not limited to, transport rollers, transport belts (with tabs and/or without tabs), vacuum transport mechanisms, transport carriages, and the like and combinations thereof. Card transport mechanisms are well known in the art including those disclosed in U.S. Pat. Nos. 6,902,107, 5,837,991, 6,131,817, and 4,995,501 and U.S. Published Application No. 2007/0187870, each of which is incorporated herein by reference in its entirety. A person of ordinary skill in the art would readily understand the type(s) of card transport mechanisms that could be used, as well as the construction and operation of such card transport mechanisms.

Referring to FIG. 4, the integrated circuit chip programming station 12 is depicted as including one or more integrated circuit chip programming mechanisms 50 and an electrostatic discharge mechanism 52. In another embodiment, the electrostatic discharge mechanism 52 may be separate from the integrated circuit chip programming station 12 as depicted in broken lines in FIG. 1.

Referring to FIGS. 2 and 4, the integrated circuit chip programming mechanism(s) 50 is configured to receive a card 14 and program the integrated circuit chip 20 on the card 14. The integrated circuit chip programming mechanism(s) 50 can have any construction that is suitable for programming the integrated circuit chip 20. The construction and operation of integrated circuit chip programming mechanisms to program an integrated circuit chip are known in the art. Once programming is complete, the card 14 is output from the integrated circuit chip programming mechanism 50 and transported out of the integrated circuit chip programming station 12 to the next station or to the card output. In an embodiment, the integrated circuit chip programming mechanism 50 may be controlled so that a card may pass-through without programming of the integrated circuit chip.

The electrostatic discharge mechanism 52 can be positioned anywhere in the system 10, 40 to contact the integrated circuit chip on the card prior to the card being input into the integrated circuit chip programming mechanism 50. The electrostatic discharge mechanism 52 is suitably configured to discharge electrostatic energy that accumulates in a portion of the card, for example in the embedded antenna 26, by contacting the integrated circuit chip 20 prior to operations on the integrated circuit chip 20 by the integrated circuit chip programming mechanism 50.

In an embodiment, the electrostatic discharge mechanism 52 that contacts the integrated circuit chip is a static dissipative material. The static dissipative material can be any static dissipative material that is suitable for contacting the integrated circuit chip to discharge electrostatic energy. In an embodiment, the static dissipative material may be a static dissipative polymer material. An example of a suitable static dissipative polymer includes, but is not limited to, a carbon impregnated nylon material. In another embodiment, the electrostatic discharge mechanism 52 that contacts the integrated circuit chip can be other types of static dissipative materials including non-polymeric materials. In an embodiment, the static dissipative material, whether polymeric or non-polymeric, that is used has a surface resistance ranging from 10⁶ to 10¹² ohms.

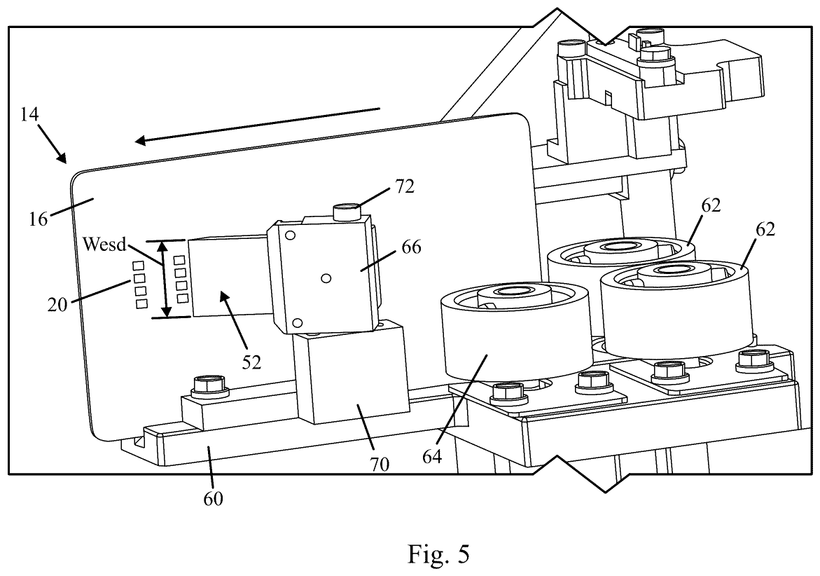

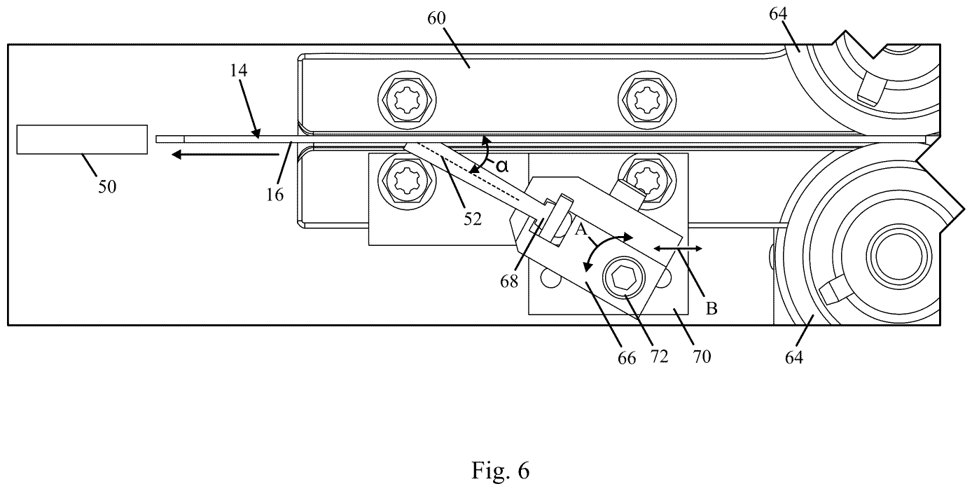

FIGS. 5 and 6 depict an example implementation of the electrostatic discharge mechanism 52. In this example implementation, the electrostatic discharge mechanism 52 is depicted as being mounted in the integrated circuit chip programming station immediately upstream of the integrated circuit chip programming mechanism 50 whereby the electrostatic discharge mechanism 52 dissipates the electrical energy immediately prior to the card 14 being input into the integrated circuit chip programming mechanism 50. However, the electrostatic discharge mechanism 52 can be mounted at other locations. The card 14 is disposed in a card track 60, and the card 14 is transported along the card travel path defined by the card track 60 via transport mechanisms 62, 64 which are depicted as transport rollers. The card 14 is transported in the direction of the arrow in FIGS. 5 and 6.

The electrostatic discharge mechanism 52 can have any form or shape that is suitable for contacting the integrated circuit chip 20 as the card 14 is transported to the integrated circuit chip programming mechanism 50. In an embodiment, the electrostatic discharge mechanism 52 may be in the form of a brush having a plurality of flexible bristles, or the electrostatic discharge mechanism 52 may be in the form of a flexible block of material, or have any other form. The electrostatic discharge mechanism 52 has a width W_{esd} that is equal to or greater than the width W_{chip} (see FIG. 2) of the integrated circuit chip 20. In the illustrated example, the width W_{esd} is depicted as being slightly greater than the width W_{chip} of the integrated circuit chip 20 to ensure that the electrostatic discharge mechanism 52 contacts the entire surface of the integrated circuit chip 20. The width W_{esd} of the electrostatic discharge mechanism 52 is also equal to or less than the width W_{c} (see FIG. 2) of the card 14. In an embodiment, the width W_{esd} of the electrostatic discharge mechanism 52 is greater than the width W_{c} (see FIG. 2) of the card 14. In an embodiment, the electrostatic discharge mechanism 52 can have a width W_{esd} that is less than the width W_{chip} of the integrated circuit chip 20. The electrostatic discharge mechanism 52 is positioned vertically to contact the integrated circuit chip 20 as the card is transported along the card track 60.

Referring to FIG. 6, the electrostatic discharge mechanism 52 projects slightly into the card transport path so that as the card travels along the card track 60, the electrostatic discharge mechanism 52 will contact the integrated circuit chip 20. At the same time, the electrostatic discharge mechanism 52 is sufficiently flexible so that the electrostatic discharge mechanism 52 will be bent slightly outward by the contact with the card. In an embodiment, the electrostatic discharge mechanism 52 may be resilient so that the electrostatic discharge mechanism 52 returns to an undeflected configuration once the card passes.

With continued reference to FIG. 6, the electrostatic discharge mechanism 52 is oriented at an acute angle α to the card travel path of the card track 60 and to the card 14. This angle helps to reduce resistance force of the electrostatic discharge mechanism 52 on the card 14 as the card 14 is being transported past the electrostatic discharge mechanism 52, and provides easier deflection of the electrostatic discharge mechanism 52. However, the electrostatic discharge mechanism 52 may be oriented at a right angle or perpendicular to the card travel path of the card track 60 and to the card 14.

The electrostatic discharge mechanism 52 can be mounted in position using any suitable mounting mechanism. FIGS. 5 and 6 illustrate an example of a mounting mechanism but many others are possible. FIGS. 5 and 6 depict the mounting mechanism as including a clamp 66 that detachably/releasably clamps an end 68 of the electrostatic discharge mechanism 52. This permits replacement of the electrostatic discharge mechanism 52 if the opposite end that contacts the integrated circuit chip 20 and the card surface 16 wears resulting from such contact. The clamp 66 is also conductive to receive electrical energy from the electrostatic discharge mechanism 52. The mounting mechanism is further depicted as including a support bracket 70 that is detachably fixed to the card track 60. The clamp 66 is fixed to the support bracket 70 to raise the electrostatic discharge mechanism 52 to the appropriate height to contact the integrated circuit chip 20. In an embodiment, the clamp 66 may be detachably fixed to the support bracket 70 by a fastener 72, such as screw. When the fastener 72 is loosened, the angle of the clamp 66, and thus the angle α of the electrostatic discharge mechanism 52, can be changed by pivoting the clamp 66 in the direction of the arrow A in FIG. 6. In addition, the position of the clamp 66 may be changed by loosening the clamp 66 or the support bracket 70 and moving the clamp 66 linearly in the direction of the arrow B in FIG. 6 in a direction parallel to the card travel path and to the card 14. In an embodiment, the movements of the clamp 66 may be automated by using one or more actuation motors connected to the clamp 66 and/or to the support bracket 70, where the actuation motor(s) can be controlled to alter the position of the clamp 66 in the direction of the arrow A and the direction of the arrow B.

In an embodiment, the electrostatic discharge mechanism 52 together with the mounting mechanism (for example, the clamp 66 and optionally the support bracket 70) can be part of an electrostatic discharge kit. The kit can be used to retrofit an integrated circuit chip programming station in a card personalization system by installing the electrostatic discharge mechanism 52, for example into the integrated circuit chip programming station. In another embodiment, the kit may also include a segment of the card track 60. This permits replacement of an existing card track, which may not be configured for use with the mounting mechanism, with the card track 60 which is configured for use with the mounting mechanism for positioning the electrostatic discharge mechanism 52.

FIG. 4 depicts the integrated circuit chip programming station 12 as including a single integrated circuit programming mechanism 50 so that a single chip on a single card is programmed in the integrated circuit chip programming station 12 at any moment in time (or the single card can be passed-through without programming). However, in an embodiment, the integrated circuit chip programming station 12 may include a plurality of the integrated circuit chip programming mechanisms 50, where each one of the integrated circuit chip programming mechanisms 50 is configured to program the integrated circuit chip on a respective one of the cards received thereby so that multiple chips on multiple cards can be simultaneously programmed in the integrated circuit chip programming station 12 at any moment in time. One or more of the integrated circuit chip programming mechanisms 50 may be controlled to allow a card to pass-through without programming of the integrated circuit chip. Alternatively, the integrated circuit chip programming station 12 may include a pass-through location that may be devoid of an integrated circuit chip programming mechanism to allow a card to pass-through without programming of the integrated circuit chip.

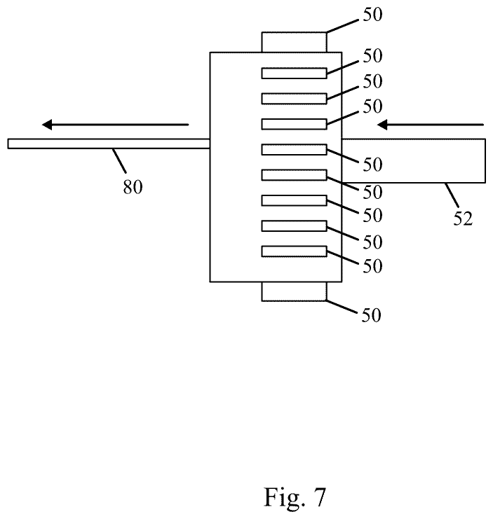

In the case of multiple integrated circuit chip programming mechanisms 50, the integrated circuit chip programming mechanisms 50 can be arranged in any suitable configuration. For example, referring to FIG. 7, the integrated circuit chip programming mechanisms 50 may be arranged in a barrel configuration. FIG. 7 depicts a side view of the barrel which can rotate about an axis that is parallel to the card transport path, with the integrated circuit chip programming mechanisms 50 disposed on an outer surface of the barrel. Each card is transported past the electrostatic discharge mechanism 52 and then sequentially introduced into a respective one of the integrated circuit chip programming mechanisms 50 as a mechanism is rotated into position in line with the upstream card track. The cards are then programmed in their respective integrated circuit chip programming mechanisms 50 as the barrel rotates. Once programming of a card is completed, the card is output onto a downstream card track 80 once the integrated circuit chip programming mechanism 50 with that card is rotated into position in line with the card track 80. Further information on a barrel with multiple integrated circuit chip programming mechanisms 50 is disclosed in U.S. Pat. No. 8,186,590 the entire contents of which are incorporated herein by reference.

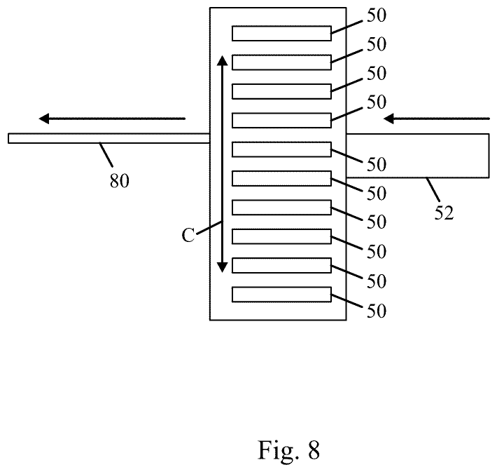

FIG. 8 illustrates multiple integrated circuit chip programming mechanisms 50 arranged in a rack configuration. In this arrangement, the integrated circuit chip programming mechanisms 50 are disposed in a linear array on a rack that is movable linearly back and forth past the upstream and downstream card tracks in the direction of the arrow C. Each card is transported past the electrostatic discharge mechanism 52 and then sequentially introduced into a respective one of the integrated circuit chip programming mechanisms 50 as the rack is moved past the upstream card track. The cards are then programmed in their respective integrated circuit chip programming mechanisms 50 as the barrel rotates. Once programming of a card is completed, the card is output onto the downstream card track 80 once the integrated circuit chip programming mechanism 50 with that card is moved into position in line with the card track 80. Further information on a rack with multiple integrated circuit chip programming mechanisms 50 is disclosed in U.S. Pat. No. 6,695,205 the entire contents of which are incorporated herein by reference.

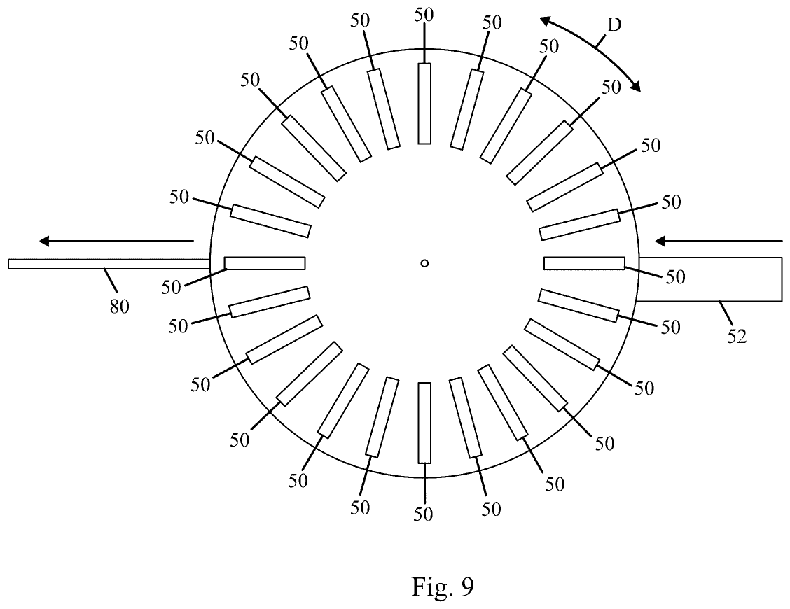

FIG. 9 illustrates multiple integrated circuit chip programming mechanisms 50 arranged in a carousel configuration. In this arrangement, the integrated circuit chip programming mechanisms 50 are disposed in a circular array on a disk that is rotatable past the upstream and downstream card tracks in the direction of the arrow D. FIG. 9 is a top view of the circular array. Each card is transported past the electrostatic discharge mechanism 52 and then sequentially introduced into a respective one of the integrated circuit chip programming mechanisms 50 as the disk is rotated past the upstream card track. The cards are then programmed in their respective integrated circuit chip programming mechanisms 50 as the disk rotates. Once programming of a card is completed, the card is output onto the downstream card track 80 once the integrated circuit chip programming mechanism 50 with that card is moved into position in line with the card track 80. Further information on a carousel with multiple integrated circuit chip programming mechanisms 50 is disclosed in U.S. Pat. No. 6,695,205 the entire contents of which are incorporated herein by reference.

The electrostatic discharge mechanism described herein can be used in card personalization systems that are configured as large volume batch production card personalization systems (or central issuance personalization systems), or used in card personalization systems that are configured as desktop card personalization systems. Large volume batch production card processing system (or central issuance processing system) process cards in high volumes, for example on the order of high hundreds or thousands per hour, and employ multiple processing stations or modules to process multiple cards at the same time to reduce the overall per card processing time. Examples of central issuance card personalization systems include the MX family of central issuance systems available from Entrust Corporation of Shakopee, Minnesota. Other examples of central issuance systems are disclosed in U.S. Pat. Nos. 4,825,054, 5,266,781, 6,783,067, and 6,902,107, all of which are incorporated herein by reference in their entirety. Desktop card personalization systems are typically designed for relatively small scale, individual card processing. In desktop personalization systems, a single card to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Corporation of Shakopee, Minnesota. Other examples of desktop card personalization systems are disclosed in U.S. Pat. Nos. 7,434,728 and 7,398,972, each of which is incorporated herein by reference in its entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A card personalization system, comprising:
a card input that is configured to input a card onto a card track, the card has an integrated circuit chip and an antenna embedded in the card that is electrically connected to the integrated circuit chip;
a card output that is configured to output the card after being processed;
an integrated circuit chip programming station downstream from the card input along the card track, the integrated circuit chip programming station includes an integrated circuit chip programming mechanism that is configured to program the integrated circuit chip on the card after the card is input into the integrated circuit chip programming station;
an electrostatic discharge mechanism mounted in the card personalization system, the electrostatic discharge mechanism includes a static dissipative material, and the electrostatic discharge mechanism is positioned and configured to contact the integrated circuit chip on the card prior to the card being input into the integrated circuit chip programming mechanism.

2. The card personalization system of claim 1, wherein the electrostatic discharge mechanism is part of the integrated circuit chip programming station.

3. The card personalization system of claim 1, wherein the integrated circuit chip programming station includes a plurality of the integrated circuit chip programming mechanisms, each one of the integrated circuit chip programming mechanisms is configured to program the integrated circuit chip on a respective one of the cards received thereby.

4. The card personalization system of claim 3, wherein the integrated circuit chip programming mechanisms are arranged in a barrel configuration, arranged in a rack configuration, or arranged in a carousel configuration.

5. The card personalization system of claim 1, wherein the electrostatic discharge mechanism comprises an electrostatic discharge brush.

6. The card personalization system of claim 1, wherein the electrostatic discharge mechanism is disposed at an acute angle to the card track.

7. The card personalization system of claim 6, wherein the electrostatic discharge mechanism is pivotable relative to the card track.

8. The card personalization system of claim 1, wherein the integrated circuit chip has a width, and the electrostatic discharge mechanism has a width that is equal to or greater than the width of the integrated circuit chip.

9. The card personalization system of claim 8, wherein the card has a width, and the width of the electrostatic discharge mechanism is equal to or less than the width of the card.

10. An integrated circuit chip programming station configured for use in a card personalization system and operable with a card which has an integrated circuit chip and an embedded antenna that is electrically connected to the integrated circuit chip, the integrated circuit chip programming station comprising:
at least one integrated circuit chip programming mechanism, the at least one integrated circuit chip programming mechanism is configured to program the integrated circuit chip on the card received thereby;
a card track leading to the at least one integrated circuit chip programming mechanism;
an electrostatic discharge mechanism adjacent to the card track, the electrostatic discharge mechanism includes a static dissipative material, and the electrostatic discharge mechanism is positioned and configured to contact the integrated circuit chip on the card prior to the card being input into the at least one integrated circuit chip programming mechanism.

11. The integrated circuit chip programming station of claim 10, wherein the integrated circuit chip programming station comprises a plurality of the integrated circuit chip programming mechanisms each of which is configured to program the integrated circuit chip on a respective one of the cards received thereby, whereby the integrated circuit chip programming mechanisms can simultaneously program the integrated circuit chips on a plurality of the cards.

12. The integrated circuit chip programming station of claim 11, wherein the integrated circuit chip programming mechanisms are arranged in a barrel configuration, arranged in a rack configuration, or arranged in a carousel configuration.

13. The integrated circuit chip programming station of claim 10, wherein the electrostatic discharge mechanism comprises an electrostatic discharge brush.

14. The integrated circuit chip programming station of claim 10, wherein the electrostatic discharge mechanism is disposed at an acute angle to the card track.

15. The integrated circuit chip programming station of claim 14, wherein the electrostatic discharge mechanism is pivotable relative to the card track.

16. The integrated circuit chip programming station of claim 11, wherein each one of the integrated circuit chips has a width, and the electrostatic discharge mechanism has a width that is equal to or greater than the width of the integrated circuit chips.

17. The integrated circuit chip programming station of claim 16, wherein each one of the cards has a width, and the width of the electrostatic discharge mechanism is equal to or less than the width of the cards.

18. An electrostatic discharge kit configured for use with an integrated circuit chip programming station in a card personalization system, the integrated circuit chip programming station includes an integrated circuit chip programming mechanism that is configured to program an integrated circuit chip on a card after the card is input into the integrated circuit chip programming station, the electrostatic discharge kit comprising:
an electrostatic discharge mechanism that is configured to be mounted in the card personalization system, the electrostatic discharge mechanism includes a static dissipative material, and when the electrostatic discharge mechanism is mounted the electrostatic discharge mechanism is positioned and configured to contact the integrated circuit chip on the card prior to the card being input into the integrated circuit chip programming mechanism.

19. The electrostatic discharge kit of claim 18, further comprising a mounting mechanism that is attached to the electrostatic discharge mechanism, and the mounting mechanism is configured to be detachably connected to the integrated circuit chip programming station.

20. The electrostatic discharge kit of claim 18, further comprising a section of card track configured to be mounted in the integrated circuit chip programming station upstream of the integrated circuit chip programming mechanism and along which the card can travel in the integrated circuit chip programming station.

21. The electrostatic discharge kit of claim 18, wherein the electrostatic discharge mechanism comprises an electrostatic discharge brush.

22. The electrostatic discharge kit of claim 18, wherein the electrostatic discharge mechanism is disposable at an acute angle to a card track of the integrated circuit chip programming station.

23. The electrostatic discharge kit of claim 22, wherein the electrostatic discharge mechanism is pivotable relative to the card track.

24. The electrostatic discharge kit of claim 18, wherein the integrated circuit chip has a width, and the electrostatic discharge mechanism has a width that is equal to or greater than the width of the integrated circuit chip.

25. The electrostatic discharge kit of claim 24, wherein the card has a width, and the width of the electrostatic discharge mechanism is equal to or less than the width of the card.
